(19) United States
(12) Patent Application Publication
(10) Pub. No.: US 2020/0173426 A1
(43) Pub. Date: Jun. 4, 2020

(54) KINETIC ENERGY ELECTRIC POWER

(71) Applicant: Keith Bandy, Modesto, CA (US)

(72) Inventor: Keith Bandy, Modesto, CA (US)

(21) Appl. No.: 16/205,060

(22) Filed: Nov. 29, 2018

(51) Int. Cl. F03G 6/04; H02K 7/18; H02K 7/02; H02K 7/116; F02C 1/05

(52) U.S. Cl. CPC F03G 6/045; H02K 7/183; H02K 7/025; H02K 7/116; F03G 2006/008; F05D 2260/43; F05D 2220/76; F05D 2220/20; F02C 1/05

(57) ABSTRACT

Kinetic Energy Electric Power is an ecofriendly method of producing utility-scale electricity. It does not need high pressure steam to operate, there is no need for expensive steam turbines, nor do any of its operating plants need to be placed within any particular geographical location or weather condition such as sunny, windy, near water, etc. This invention is driven by heated air flowing through a system of solar thermal panels containing mineral oil, or another suitable heat-retaining liquid, that is circulated within a closed circuit piping network through one or more thermal energy storage tanks then through heat exchangers located in one or more large heat chambers that have a chimney stack extending skyward in order to facilitate the draft of air. As the air inside the chambers is heated and expands, it is forced out the top, because of stack effect, through the chimney, thus forcing fresh air to flow in through an opening at the chambers' bottom that brings outside air in via a passageway and travels through one or more paddlewheel-like wind turbines that drive multiple large, weighted flywheels that have multiple electric generators attached to them via gear/clutch mechanisms and producing utility-grade electricity 24/7, 365.

K.E.E.P. is an ecofriendly system and method of producing utility-scale electricity. It does not need high pressure steam to operate, there is no need for expensive steam turbines, nor does it need to be placed within any particular geographical location or weather condition such as sunny, windy, near water, etc. This invention is driven by heated air flowing through a system of solar thermal panels containing mineral oil, or another suitable heat-retaining liquid, that is circulated through a closed circuit piping network through one or more thermal energy storage tanks then through a heat exchanger located in one or more large inverted funnel-shaped chambers that have their small ends pointing vertically upward. As the air inside the chambers is heated and expands, it is forced out the top, because of stack effect, through the chimney-like small end, thus forcing fresh air to flow in through an opening at the chambers' bottom that brings outside air in via a passageway and travels through one or more paddlewheel-like wind turbines that drive multiple large, weighted flywheels that have multiple electric generators attached to them via gear/clutch mechanisms.

### ADVANTAGEOUS EFFECTS OF INVENTION

This invention has several advantages over present methods of producing utility grade electricity. These advantages include:

1. Does not require the use of high heat, pressure or steam;
2. Does not require being placed within specific topographical locations or weather conditions:
3. Can be constructed primarily underground with aboveground facilities resembling a standard Midwestern farm:
4. Functions effectively with operating temperatures not exceeding 300° F.; and
5. Stores sufficient heat energy in thermal energy storage (TSE) tanks (with minimal assistance from a small natural gas heater) to operate effectively 24/7 even when the sun is not shining.

### DESCRIPTION OF DRAWINGS

FIG. 1 illustrates the present invention being located primarily underground, although it can also be located above ground where it could resemble a standard fossil fuel plant but without the fossil fuels. If located belowground its aboveground facilities can resemble a typical Midwestern farm comprising one or more structures similar to grain silos (2), a farmhouse (5) that acts as the site's command center with solar thermal panels on its roof containing mineral oil, or another suitable heat-retaining fluid, that circulates between the solar panels (4), and a barn (3) housing one or more thermal energy storage tanks and heat exchangers (13). Belowground is the site's primary structure housing one or more large, at least 150,000 square meters, inverted funnel-shaped chambers (12) with its upper section acting as a chimney dispensing hot air (1) and a closed loop tubing system (11) that acts as a heat exchanger circulating hot liquid from the heat exchangers in the barn structure. Number (6) depicts a typical electric power plant transformer yard connected to the power grid (7). Also shown is a personnel/equipment elevator (10), the front view of the air turbine and associated flywheel assembly (9), and exterior air intake shaft (8).

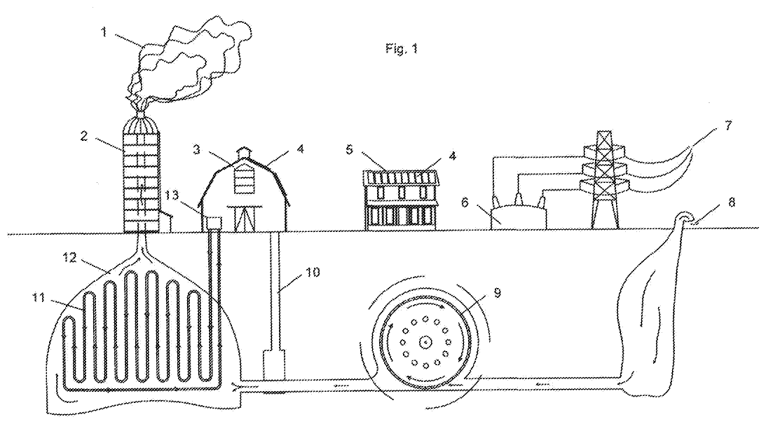

FIG. 2 illustrates the top down view of the wind turbine, (17) and fly wheels (15) supported by a typical axle support system such as large pillow block bearings (14). Also illustrated is an electric generator (18) attached via a gear/clutch system (19) that resembles a car/truck rear axle/drive shaft assembly that connects with the gear ring (16) attached to the flywheels, which allows the generators to alternate between the flywheel that is freewheeling and driving the generators to the flywheel that is being spun up to speed and is connected to the drive axel via a clutch system.

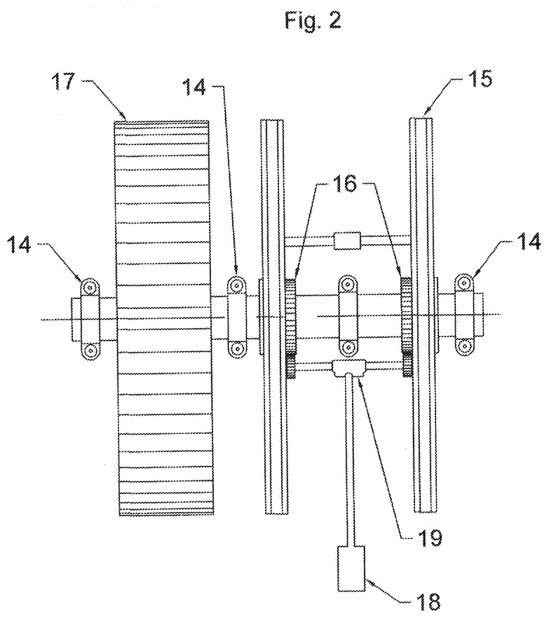

FIG. 3 illustrates flywheel (22), and generators (20), with their drive shafts (23), as they are connected together with a gear/clutch mechanism (24) that resembles a car/truck rear axle/drive shaft assembly that connects with the gear ring (26) attached to the flywheels that are attached to the main drive shaft (21). As the wind turbine turns, due to air being pressed against its turbine blades, the drive shaft also turns, which causes the generators to turn because of their drive shaft connection to the drive wheel via the gear/clutch mechanism. Structures supporting the generators will be typical gantry/walkway structures for inspection and maintenance access purposes.

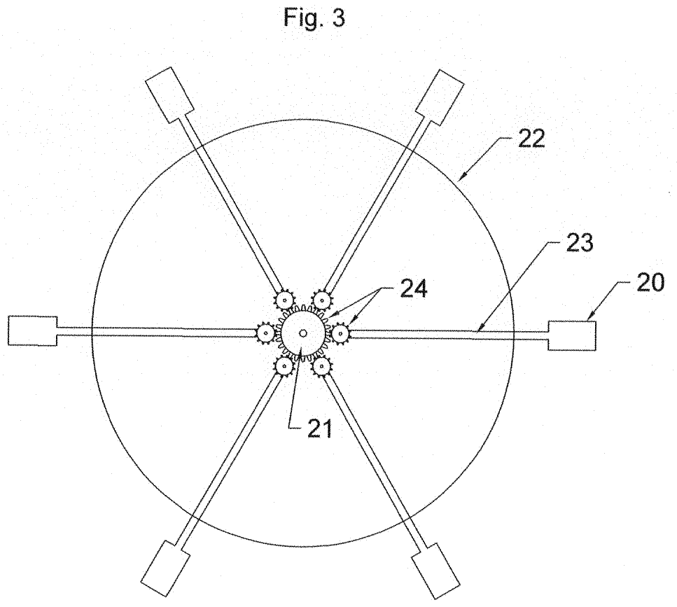

FIG. 4 illustrates the end view showing the wind turbine (25), and the main drive shaft support structure (26).

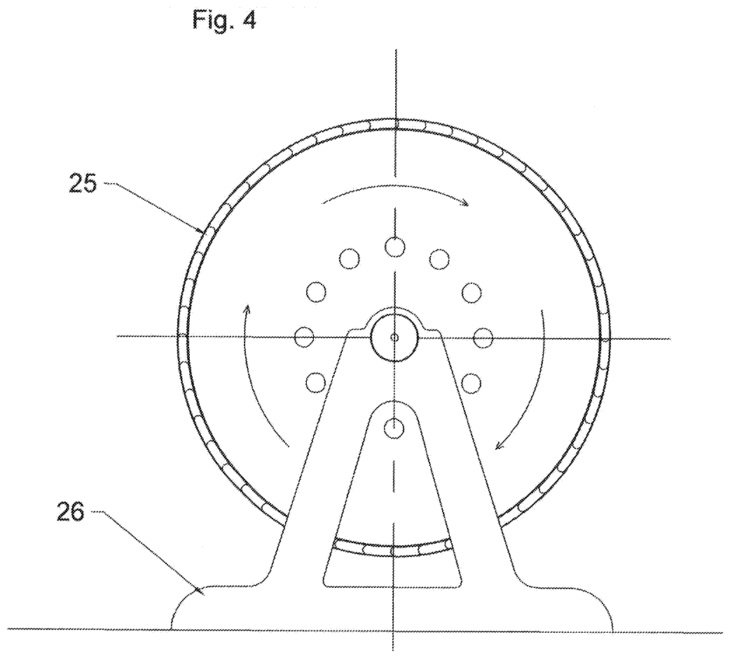

### BACKGROUND OF THE INVENTION

### Field of the Invention

The present invention relates generally to the creation of flowing air for the purpose of generating electricity.

The present invention consists of large paddlewheel-like wind turbines shaped to achieve maximum efficiency and connected to electric generators via a shaft/clutch mechanism for the purpose of generating utility-scale electricity.

### Description of the Related Art

The generation of electricity has been around since British scientist Michael Faraday discovered its fundamental principles in the 1820s and early 1830s. He proved electricity could be produced by the movement of a loop of wire, or disc of copper between the poles of a magnet. Within a few years, and with the innovative spirits of such men as George Westinghouse and Nikola Tesla, central power stations became economically practical with the development of alternating current power transmission and using transformers to transmit power at high voltage for long distances with low loss. Commercial electric power generation has changed little since the days of Westinghouse and Tesla. However, energy's sources have changed considerably. Originally the primary source for creating utility-scale electricity was from hydro; falling water (Niagara falls). Then came coal, which was portable and could fire boilers to create steam to drive steam turbines connected to one or more electric generators. From those meager beginnings other “fuel” sources for generating electricity became available such as oil, natural gas, and eventually nuclear, solar, and wind.

Currently, the percent of primary sources of electricity in the U.S. are: fossil fuels 62.9; nuclear 20; hydropower 7.4; wind 6.3; biomass 1.6; solar 1.3 percent; and other 0.5.

One of the main concerns facing the planet today is finding alternative, renewable energy sources to replace conventional power plants that burn fossil fuels. These plants produce a host of unwanted greenhouses gases, which have been proven to be a major contributor of global warming. In an effort to combat this, multiple ecofriendly devices have been invented that use air as their driving force.

Below are a few:

| | | Publication | | |
|---|---|---|---|---|
| Patent No. | Priority Date | Date | Assignee | Title |
| U.S. Pat. No. | 1977 Jul 21 | 1981 Jun. 23 | Lucier Robert | System for converting solar |
| 4,275,309A | | | | heat to electrical energy |
| U.S. Pat. No. | 1992 Sep. 9 | 1995 Mar. 7 | UC Regents | Convection towers |
| 5,395,598A | | | | |
| U.S. Pat. No. | 2001 Aug. 6 | 2003 Sep. 30 | Awa Research | Column airflow power |
| 6,626,636B2 | | | | apparatus |
| U.S. Pat. No. | 1996 Jun. 14 | 2003 Nov. 18 | Sharav Sluices, | Renewable resource |
| 6,647,717B2 | | | Ltd. | hydro/aero-power |
| | | | | generation |
| U.S. Pat. No. | 2003 Jul. 21 | 2010 Jul. 20 | Morph Pty, Ltd. | Power generation from |
| 7,757,490B2 | | | | solar and waste heat |
| U.S. Pat. No. | 2003 Feb. 23 | 2010 Oct. 26 | Le John O | Hybrid solar thermal |
| 7,821,151B2 | | | | chimney |

### SUMMARY

The present invention provides a system and method for generating electricity comprised of:

1. Solar collectors on the roofs of aboveground buildings and placed in other locations on the property as needed and configured to heat mineral oil, or other suitable heat-retaining liquids, contained in a closed loop piping system for the purpose of heating the air in a large confined space through the use of one or more thermal energy storage systems;

2. Using an alternating heat source such as natural gas or biofuels when solar panels are insufficient to maintain heat demand;

3. One or more large paddlewheel-like wind turbines that are connected via drive shaft, gear, and clutch mechanisms to one or more pairs of large, weighted flywheels that are connected in a similar manner to one or more electric generators;

4. The flywheels automatically, via electric sensors and clutches, engage to and disengage from the wind turbine shaft according to the speed of the flywheels;

5. Hot mineral oil, or other suitable heat-retaining fluids, that heats the TES fluid acts as a heat exchanger transferring the heat from the solar collectors to the closed loop piping system that circulates the hot oil from the TES to the large confined space where the space's interior is heated and causes it to rise out its chimney due to the stack effect;

6. A natural gas or biofuel heater backup system connected to one or more of the TES tanks that helps heat the mineral oil during periods of maintenance and repair of the solar array system or during long periods of adverse weather conditions; and

7. Multiple electric generators attached to the flywheels via transaxle assemblies that resembles a car or truck rear axle and drive shaft assembly in a way that automatically alternates power from the flywheel that is spinning free and driving the generators and is slowing down due to their drag torque to the flywheel that has been sped up to sufficient speed to drive the generators and allow sufficient time for the other flywheel to be sped up to speed.

1. A system for generating electricity from kinetic energy comprising: a Heating Unit and a Power Unit combined to make a Production Unit for the purpose of producing utility-grade electricity.

2. The Heating Unit of claim 1 further comprising:
A Heat Chamber constructed of suitable heat resistant materials and shaped similar to a standard residential fireplace except much larger in order to obtain maximum efficiency of heat and air flow through the chamber and up its extended chimney causing a sufficient stack effect to occur;
There is at least one Thermal Energy Storage tank or pit that is large enough to be effective for the site in retaining heat and is filled with suitable heat retaining materials such as rock boulders, blocks of concrete or iron, liquid sodium, mineral oil or another suitable heat-retaining material.
A suitable Heat-retaining Liquid contained in a Tube/Pump System that automatically and continually circulates, via a series of pumps, the hot liquid between the Solar Thermal Panels, which are placed in advantageous places throughout the property and in sufficient numbers as to maintain minimal heat operating conditions, one or more thermal energy storage tanks or pits, and a heat exchanger located inside the heat chamber;
Heat Exchangers are placed in the thermal energy storage tanks and heat chambers and receive hot liquid that is contained in a tube/pump system that automatically and continually circulates it from and back to the thermal energy storage tanks;
A system of Heat and Corrosion Resistance Tubing/Piping is used for all circulating liquid;
A Backup Heat Source, such as a small boiler, using natural gas, biofuels, or another suitable low-emission combustible product is used to supplement the solar thermal panels and thermal energy storage tanks when they are not providing above minimal heat performance capacity due to the lack of sufficient sunshine.

3. The Power Unit of claim 1 further comprising:
One or more paddlewheel-like shaped Wind Turbines large enough to be efficient for their purpose and with blades shaped to best capture wind is placed approximately half way along a pipe that is of an optimum size as to accommodate the wind turbine and connecting the outside air inlet source to the bottom of the heat chamber, and positioned on a drive shaft supported by large pillow block bearings;
Two Flywheels large enough and weighted sufficiently to obtain maximum kinetic energy for their purpose, are connected to the wind turbine via a shaft and spun up, via clutches and gears, by the wind turbine to a speed that is sufficient to effectively operate the generators;
Either two 3 MW, four 1½ MW, or six 1 MW Electric Generators are connected to the flywheels through a Transaxle-like Device that resembles the rear axle assembly of a rear wheel drive motor vehicle and has a series of gears and clutches that allows for power to alternate between the flywheel that is connected to the wind turbine shaft and is being spun up to speed, and the flywheel that is disconnected from the wind turbine shaft, is connected to the generators and is free-spinning so electricity can be produced without interruption;
As the air in the heat chamber is heated, thus rising and passing out the stack, cooler more dense air is drawn into the chamber at its bottom through the pipe connecting the outside air source to the heat chamber and passing through the wind turbine causing it to turn;
As one of the two flywheels is being automatically disconnected from the wind turbine and is free-spinning via kinetic energy and driving the generators, the other flywheel, once disconnected from the generators, is in the process of being brought up to speed (at least 60 RPM) by the wind turbine through a clutch system connecting the flywheels to the wind turbine shaft;
As the flywheel that is connected to the generators slows down because of the drag of the generators connected to it, a point is reached when the flywheel no longer has enough kinetic energy to drive the generators effectively, thus causing the transfer of power from the wind turbine to automatically shift to the up-to-speed, free-spinning flywheel and is being connected to the generators. This process is continually in motion through an automatic monitoring system ensuring there is no disruption in the facility's electricity production.
